(19) United States
(12) Patent Application Publication
(10) Pub. No.: US 2010/0322269 A1
(43) Pub. Date: Dec. 23, 2010

(54) TUNABLE LASER

(75) Inventor: Jian-Yu Liu, Boulder, CO (US)

Correspondence Address: DORR, CARSON & BIRNEY, P.C., 501 SOUTH CHERRY STREET, SUITE 800, DENVER, CO, 80246, US

(73) Assignee: COGO OPTRONICS, INC., Boulder, CO (US)

(21) Appl. No.: 12/486,310

(22) Filed: Jun. 17, 2009

(51) Int. Cl. H01S 3/10; G02F 1/13

(52) U.S. Cl. 372/20; 349/198

(57) ABSTRACT

A tunable laser has a gain material and a mirror defining an external resonant cavity. A tunable Fabry-Perot etalon disposed along the optical path between the mirror and the gain material includes a liquid crystal layer having a variable refractive index to tune the transmission peaks of the etalon and the resonant frequency of the laser resonant cavity. A second etalon having a fixed set of transmission peaks can also be included in the laser resonant cavity. The tunable etalon is then tuned to select a resonant frequency corresponding to one of the transmission peaks of the fixed etalon.

### BACKGROUND OF THE INVENTION

1. Field of the Invention

The present invention relates generally to the field of tunable lasers. More specifically, the present invention discloses an external cavity wavelength-tunable laser (ECTL) that employs a Fabry-Perot etalon with a liquid crystal layer for tuning.

2. Statement of the Problem

A wide variety of tunable lasers have been developed in the past, and are commonly used in the field of optical communications. The prior art in this field includes tunable lasers based on acousto-optical tunable filters (AOTF), as discussed at length for example in U.S. Pat. No. 5,329,397 (Cheng). However, this approach has the disadvantage of requiring moving parts.

Other tunable lasers use a diffraction grating for wavelength tuning. Examples of this technology are disclosed in U.S. Pat. No. 5,67,512 (Sacher) and U.S. Pat. No. 5,524,012 (Wang et al.). This approach also has the disadvantage of requiring the movement of mechanical parts.

One response in the prior art has been to use a liquid crystal pixel mirror (LCPM) or liquid crystal spatial light modulator (LC-SLM) in place of mechanical components for tuning. For example, Mizutani et al. (IEEE Photonics Technology Letters, vol. 18, no. 12, Jun. 15, 2006) have disclosed an external cavity wavelength-tunable laser with a liquid crystal mirror and a Fabry-Perot etalon having fixed transmission peaks.

3 Solution to the Problem

None of the prior art references discussed above show an external cavity wavelength-tunable laser having the optical configuration of the present invention. In particular, the present invention employs a Fabry-Perot etalon having a liquid crystal layer to tune the transmission peaks of the etalon. This approach eliminates the need for moving mechanical parts found in many prior art tunable lasers. The present invention allows the “tuner” functionality to be integrated into the etalon, thereby combining two functions into one device. In addition, the liquid crystal Fabry-Perot etalon can be incorporate a silicon back plane so that the etalon can be fabricated using LCoS (liquid crystal on silicon) techniques, which are well suited for high-volume manufacturing.

### SUMMARY OF THE INVENTION

This invention provides a tunable laser having a gain material and a mirror defining an external resonant cavity. A tunable Fabry-Perot etalon disposed along the optical path between the mirror and the gain material includes a liquid crystal layer having a variable refractive index to tune the transmission peaks of the etalon and the resonant frequency of the laser resonant cavity. A second etalon having a fixed set of transmission peaks can also be included in the laser resonant cavity. The tunable etalon is then tuned to select a resonant frequency corresponding to one of the transmission peaks of the fixed etalon.

These and other advantages, features, and objects of the present invention will be more readily understood in view of the following detailed description and the drawings.

### BRIEF DESCRIPTION OF THE DRAWINGS

The present invention can be more readily understood in conjunction with the accompanying drawings, in which:

FIG. 1 is a schematic diagram of a tunable laser embodying the present invention.

FIG. 2 is a schematic diagram of a tunable laser with two tunable etalons.

FIG. 3 is a diagram illustrating the wavelength spacing of the external laser cavity modes, and the transmission peaks of a fixed etalon and a tunable etalon.

FIG. 4 is a cross-sectional diagram illustrating the layers of a tunable Fabry-Perot etalon 40 having a liquid crystal on silicon (LCoS) structure.

FIG. 5 is a cross-sectional diagram illustrating the layers of an embodiment of a tunable Fabry-Perot etalon 40 with glass substrates.

FIG. 6 is a graph showing an example of the transmission function of a tunable Fabry-Perot etalon 40.

FIG. 7 is a graph showing an example of laser cavity stability characteristics as a function of frequency for the tunable laser.

FIG. 8 is a graph showing an example of the mode rollover characteristics as a function of frequency for the tunable laser.

FIG. 9 is a graph showing an example of the cavity power profile as a function of frequency for the tunable laser.

FIG. 10 is a graph showing an example of the cavity phase distribution over a range of 100 channels.

FIG. 11 is a graph showing an example of the left side mode suppression ratio (SMSR) as a function of cavity length for the tunable laser.

FIG. 11 is a graph showing an example of the right side mode suppression ratio as a function of cavity length for the tunable laser.

### DETAILED DESCRIPTION OF THE INVENTION

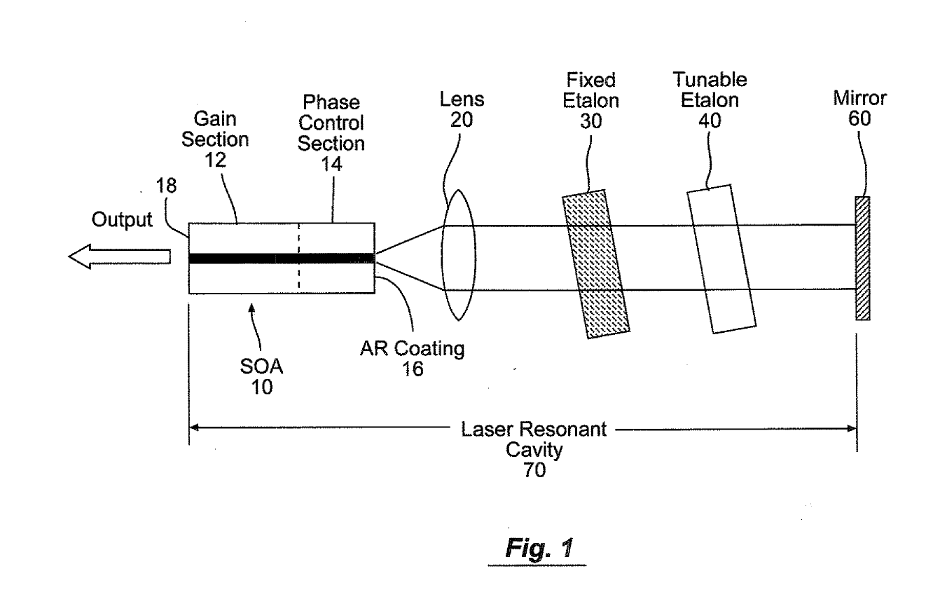

Turning to FIG. 1, a schematic diagram is provided showing one embodiment of the present invention. The laser includes a gain material 10 with two endfaces 16 and 18. A mirror 60 is positioned to reflect light emitted from the first endface 16 back to the gain material 10, thereby defining a laser resonant cavity 70 along an optical path between the mirror 60 and the second endface 18 of the gain material 10.

For example, the gain medium 10 can be a semiconductor optical amplifier (SOA), as shown in the embodiment depicted in FIG. 1. Semiconductor optical amplifiers are commercially-available amplifiers that use a semiconductor to provide the gain medium. These amplifiers have a similar structure to Fabry-Perot laser diodes but with anti-reflection design elements at the endfaces 16 and 18. Semiconductor optical amplifiers are typically made from group III-V compound semiconductors such as GaAs/AlGaAs, InP/InGaAs, InP/InGaAsP and InP/InAlGaAs, although other direct band gap semiconductors such as II-VI could be used. SOAs are electrically pumped. Alternatively, the gain medium could be any of a variety of optically-pumped materials, such as Nd—YAG and Nd glass.

As shown in FIG. 1, the SOA 10 can have a gain section 12 and a phase control section 14 that are monolithically integrated by butt-joint technology. Alternatively, phase control can be achieved by a free-space liquid-crystal phase shifter (controller). In the embodiment in FIG. 1, the first endface 16 of the SOA 10 at the phase control section 14 has an anti-reflective coating, and the second endface 18 of the SOA 10 has a low-reflective coating.

A fixed etalon 30 can be placed along the optical path of the laser resonant cavity 70. This can be a Fabry-Perot etalon having two parallel partially-reflective mirrors spaced apart from one another. Light entering the fixed etalon 30 undergoes multiple internal reflections between the mirrors resulting in a transmission spectrum as a function of wavelength exhibiting a plurality of fixed transmission peaks corresponding to resonances of the fixed etalon 30. The fixed etalon 30 assists in mode suppression of the cavity modes neighboring the desired lasing cavity mode, as will be discussed below. In addition, the transmission peaks of the fixed etalon 30 can serve as wavelength references for the ITU wavelength channels, which makes this embodiment well suited for telecommunications applications.

In the embodiment shown in FIG. 1, a collimating lens 20 disposed between the first endface 16 of the SOA 10 and the etalon 30 provides an optical interface to adjust the beam size between these components.

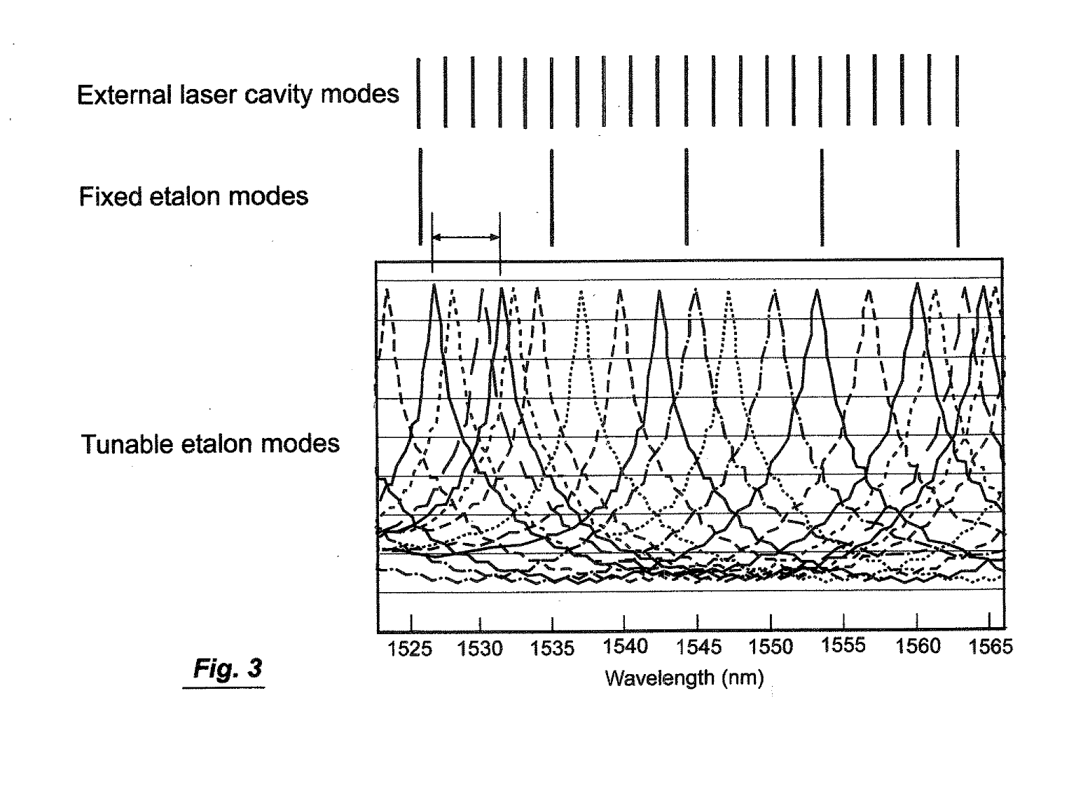

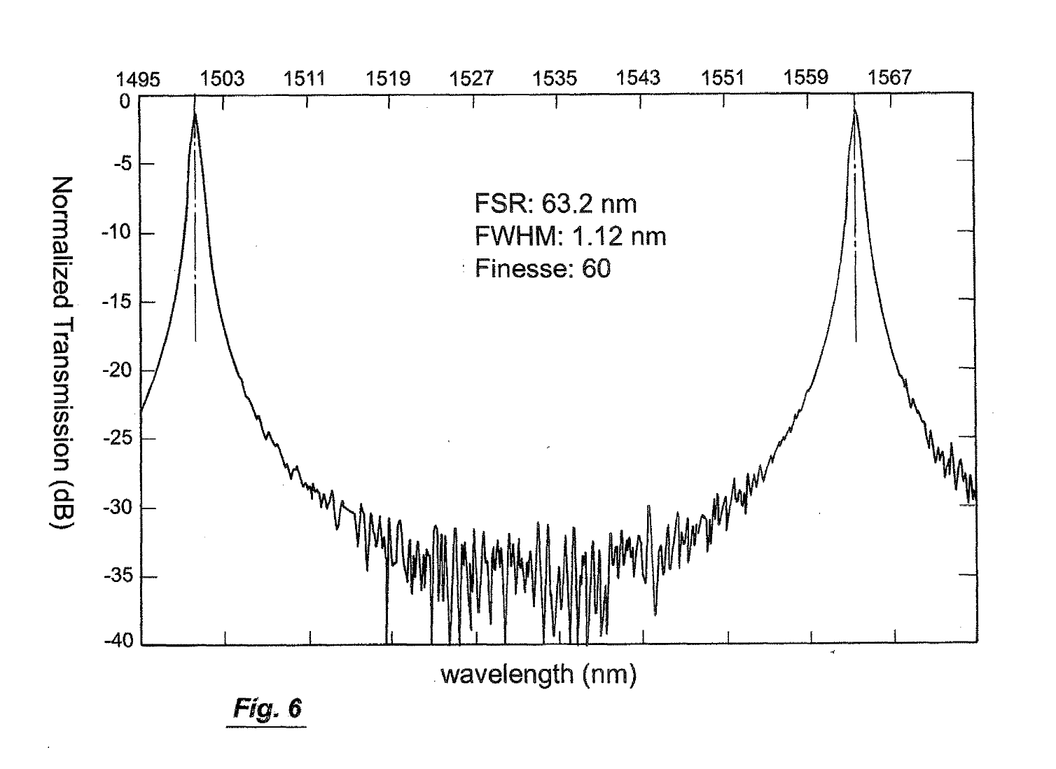

At least one tunable Fabry-Perot etalon 40 is disposed along the optical path of the laser resonant cavity 70. The tunable etalon 40 has two partially-reflective mirrors that are parallel to, and spaced apart from one another. Here again, light entering the etalon 40 undergoes multiple internal reflections between the mirrors resulting in a transmission spectrum as a function of wavelength exhibiting at least one transmission peak corresponding to resonances of the etalon 40. A liquid crystal layer is disposed between the mirrors having a variable refractive index to tune the transmission peaks of the etalon 40 and the resonant frequency of the laser resonant cavity 70. FIG. 6 is a graph showing an example of the resulting transmission function of a tunable Fabry-Perot etalon 40 with two transmission peaks. The graph provided in the lower portion of FIG. 3 show how these transmission peaks can be selectively shifted over a range of frequencies by adjusting the refractive index of the liquid crystal layer.

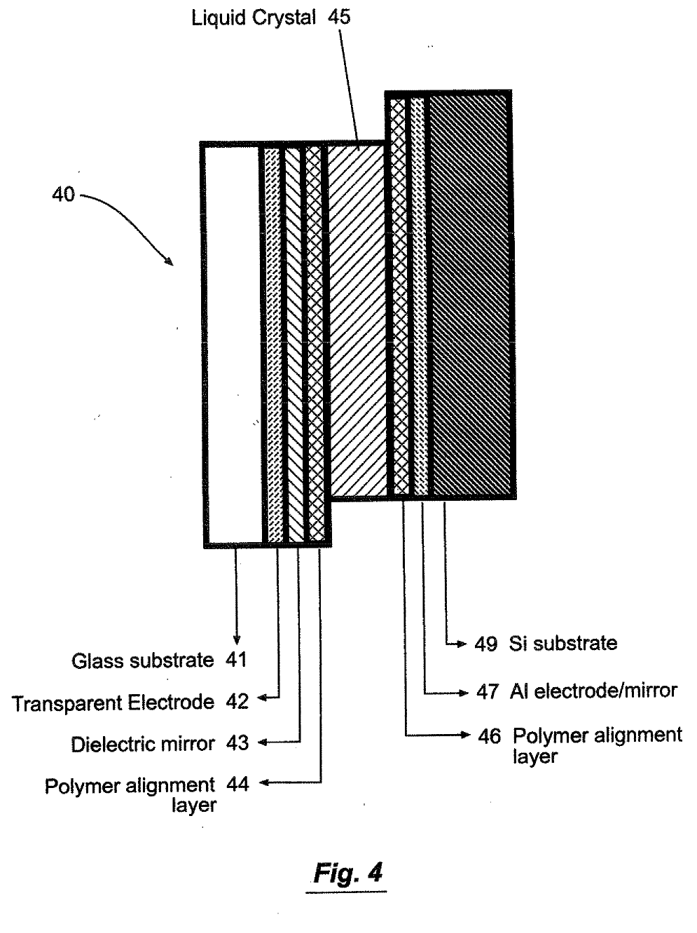

FIG. 4 illustrates the layers in one embodiment of a tunable etalon 40 fabricated using liquid crystal on silicon (LCoS) techniques. A silicon substrate 49 is the initial layer. An aluminum electrode/mirror 47 is then formed on the substrate 49 to serve both as one of the partially-reflective mirrors of the etalon and one of the electrodes for a liquid crystal layer 44. The liquid crystal layer 45 with polymer alignment layers 44 and 46 are then assembled with a second partially-reflective mirror 43 and transparent electrode 42. A glass substrate 41 covers the assembly.

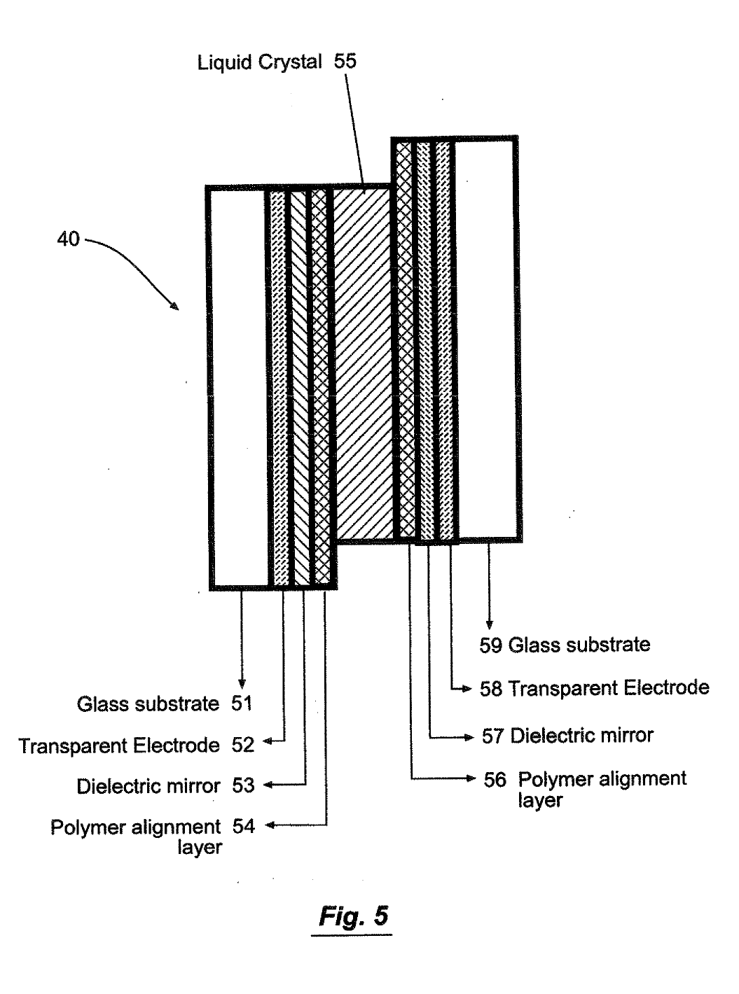

FIG. 5 illustrates the layers in another embodiment of a tunable etalon 40 assembled between two glass substrates 51 and 59. Transparent electrodes 52, 58, partially-reflective mirrors 53, 57, and polymer alignment layers 54, 56 are created on the medial surfaces of the glass substrates 51, 59. A liquid crystal layer 55 is sandwiched between these alignment layers 54, 56. It should be understood that other fabrication techniques could be employed, and that other layers and materials could be used in the etalons.

FIG. 3 is a diagram illustrating the wavelength spacing of the external laser cavity modes, and the transmission peaks of a fixed etalon 30 and the tunable etalon 40. The transmission peaks of the fixed etalon 30 essentially provide coarse tuning of the lasing cavity mode. The transmission peaks of the tuning etalon 40 can be shifted over the range of the frequency band to provide fine tuning to select the desired lasing cavity mode. It should be noted that both the fixed etalon 30 and tunable etalon 40 assist in mode suppression of the cavity modes neighboring the desired lasing cavity mode.

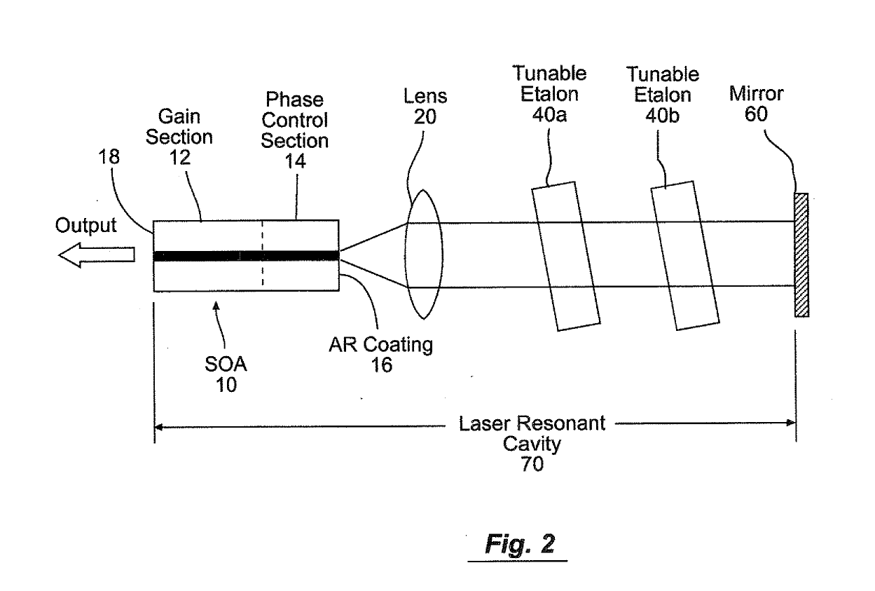

FIG. 2 is a schematic diagram of another embodiment of the present invention that employs two tunable Fabry-Perot etalons 40a and 40b in series along the optical path of the laser resonant cavity 70. Both etalons 40a, 40b can be tuned across a range of wavelengths. For example, one of the tunable etalons 40a, 40b can be used for coarse tuning, while the other tunable etalon provides fine tuning over a narrower range. This embodiment may be better suited for applications other than telecommunications, which do not employ a fixed grid of ITU wavelength channels. Moreover, this configuration provides an additional range for tuning, and enhances the performance characteristics of the device. It should be understood that other configurations or combinations of tunable and fixed etalons could be substituted.

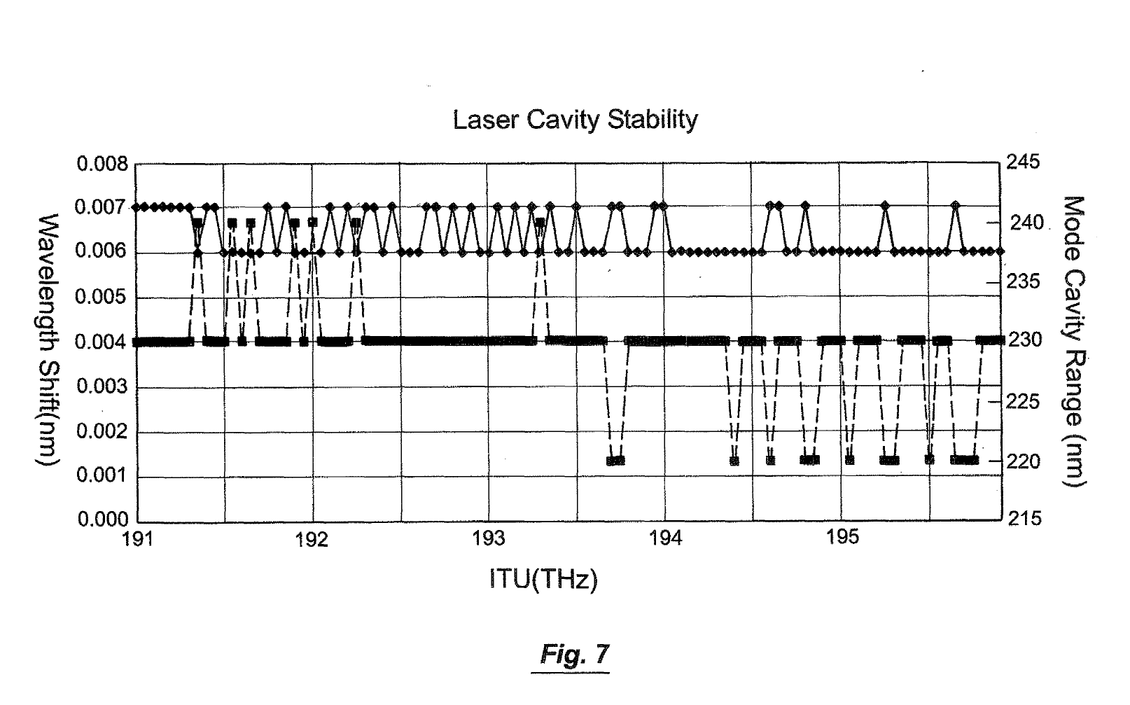

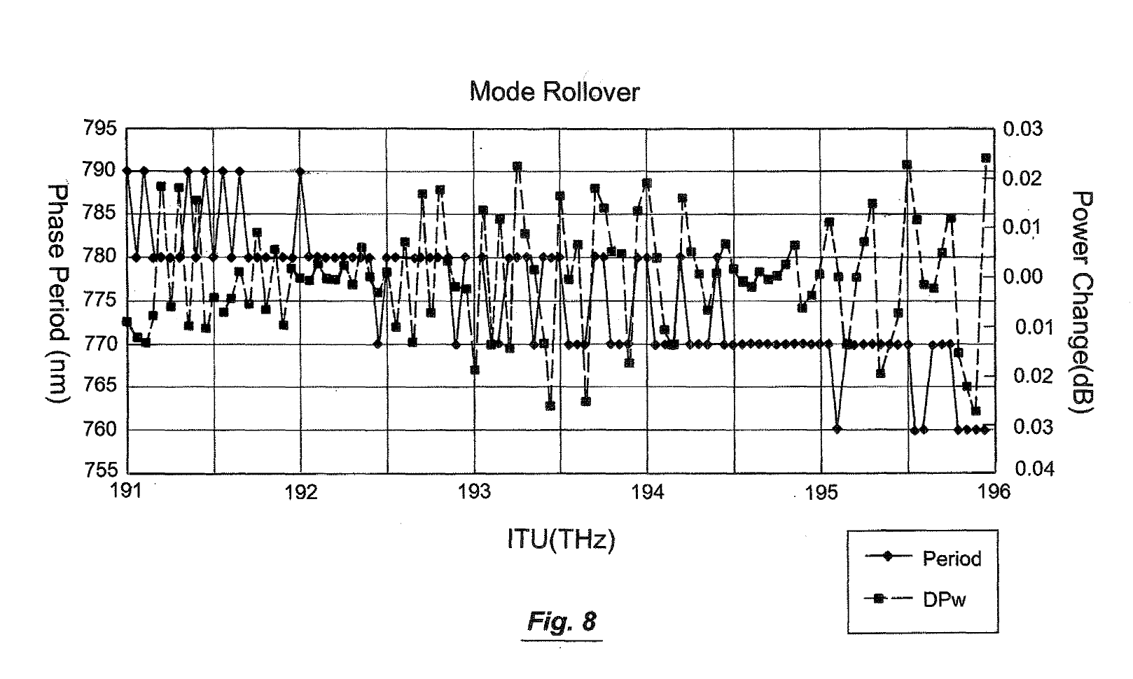

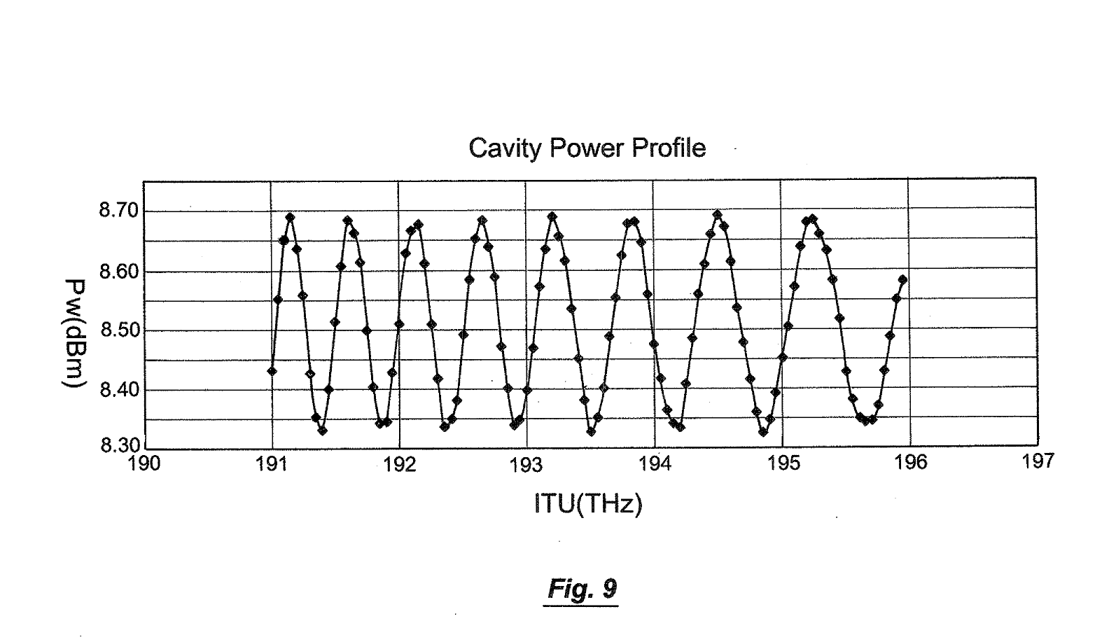

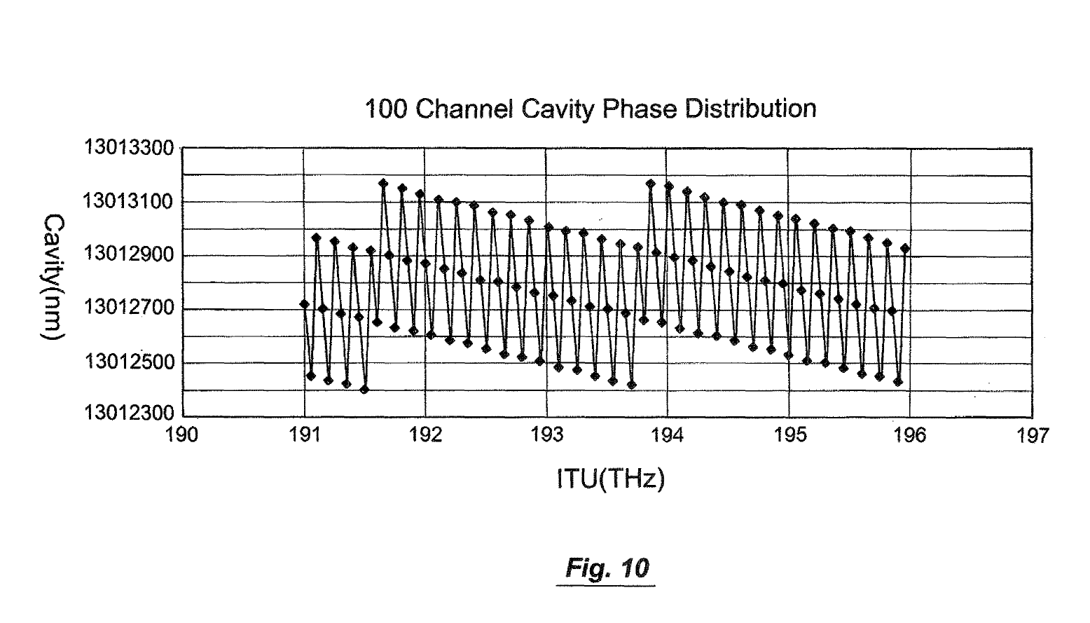

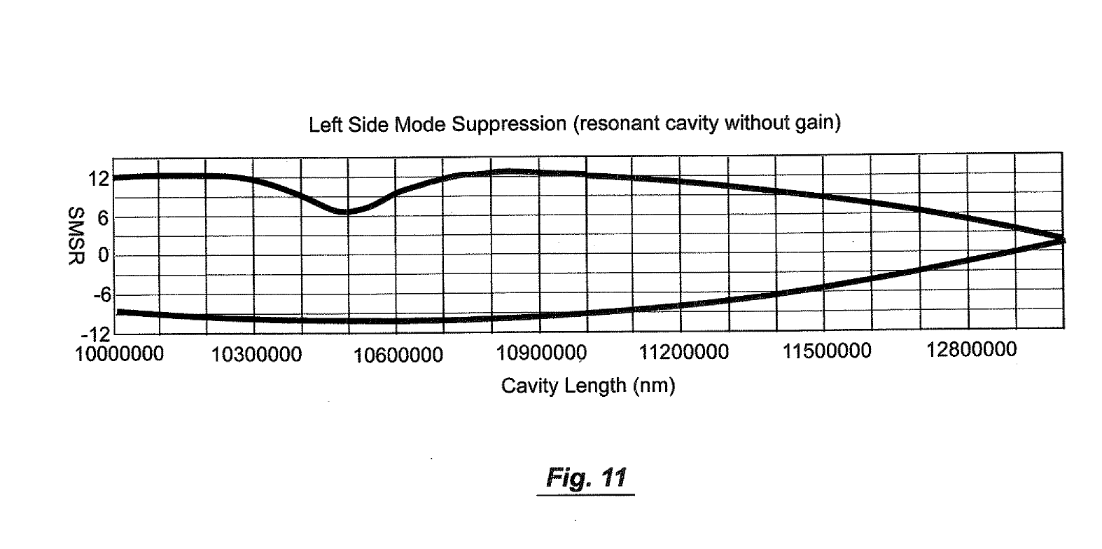

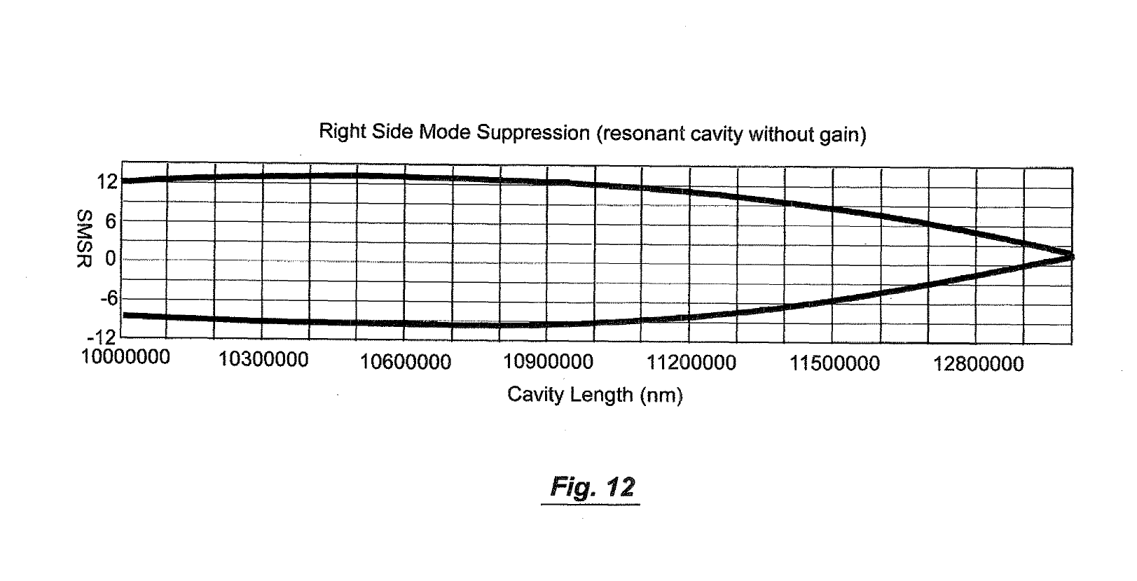

FIGS. 7-12 are graphs showing examples of the performance of a tunable laser embodying the present invention. In particular, FIG. 7 shows its laser cavity stability characteristics as a function of frequency. FIG. 8 illustrates its mode rollover characteristics as a function of frequency. FIG. 9 is a graph showing the cavity power profile as a function of frequency. FIG. 10 is a graph showing the cavity phase distribution over a range of 100 channels. FIG. 11 is a graph showing of the left side mode suppression ratio (SMSR), and FIG. 11 shows the right side mode suppression ratio as a function of cavity length.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

I claim:

1. A tunable laser comprising:
a gain material having first and second endfaces emitting light from the first endface;
a mirror positioned to reflect the light back to the gain material, thereby defining a laser resonant cavity along an optical path between the mirror and the second endface of the gain material; and
a tunable Fabry-Perot etalon disposed along the optical path between the mirror and the gain material, said etalon having:
(a) a partially-reflective first mirror;
(b) a partially-reflective second mirror parallel to, and spaced apart from the first mirror, whereby light entering the etalon undergoes multiple internal reflections between the first and second mirrors resulting in a transmission spectrum as a function of wavelength exhibiting at least one transmission peak corresponding to resonances of the etalon; and
(c) a liquid crystal layer disposed between the first and second mirrors having a variable refractive index to tune the transmission peaks of the etalon and the resonant frequency of the laser resonant cavity.

2. The tunable laser of claim 1 further comprising a fixed etalon disposed along the optical path between the mirror and the gain material, said fixed etalon having a plurality of fixed transmission peaks corresponding to resonances of the fixed etalon, and wherein the tunable etalon is tuned to select a resonant frequency corresponding to one of the transmission peaks of the fixed etalon.

3. The tunable laser of claim 1 wherein said tunable etalon further comprises a silicon back plane, and wherein the etalon is fabricated as a liquid crystal on silicon structure on the silicon back plane.

4. The tunable laser of claim 1 wherein the gain material comprises a semiconductor optical amplifier.

5. The tunable laser of claim 4 wherein the semiconductor optical amplifier comprises a gain section and a phase control section.

6. A tunable laser comprising:
a gain material having first and second endfaces emitting light from the first endface;
a mirror positioned to reflect the light back to the gain material, thereby defining a laser resonant cavity along an optical path between the mirror and the second endface of the gain material;
a fixed etalon disposed along the optical path between the mirror and the gain material, said fixed etalon having a transmission spectrum as a function of wavelength exhibiting a plurality of fixed transmission peaks corresponding to resonances of the fixed etalon; and
a tunable Fabry-Perot etalon disposed along the optical path between the mirror and the gain material, said etalon having:
(a) a partially-reflective first mirror;
(b) a partially-reflective second mirror parallel to, and spaced apart from the first mirror, whereby light entering the tunable etalon undergoes multiple internal reflections between the first and second mirrors resulting in a transmission spectrum as a function of wavelength exhibiting at least one transmission peak corresponding to resonances of the tunable etalon; and
(c) a liquid crystal layer disposed between the first and second mirrors having a variable refractive index to tune the transmission peaks of the tunable etalon and the resonant frequency of the laser resonant cavity to a selected one of the transmission peaks of the fixed etalon.

7. The tunable laser of claim 6 wherein the gain material comprises a semiconductor optical amplifier.

8. The tunable laser of claim 7 wherein the semiconductor optical amplifier comprises a gain section and a phase control section.

9. The tunable laser of claim 6 wherein said tunable etalon further comprises a silicon back plane, and wherein the etalon is fabricated as a liquid crystal on silicon structure on the silicon back plane.

10. A tunable laser comprising:
a semiconductor optical amplifier having first and second endfaces emitting light from the first endface;
a mirror positioned to reflect the light back to the semiconductor optical amplifier, thereby defining a laser resonant cavity along an optical path between the mirror and the second endface of the semiconductor optical amplifier having multiple laser cavity modes; and
a tunable Fabry-Perot etalon disposed along the optical path between the mirror and the semiconductor optical amplifier, said etalon having:
(a) a partially-reflective first mirror;
(b) a partially-reflective second mirror parallel to, and spaced apart from the first mirror, whereby light entering the etalon undergoes multiple internal reflections between the first and second mirrors resulting in a transmission spectrum as a function of wavelength exhibiting at least one transmission peak corresponding to resonances of the etalon; and
(c) a liquid crystal layer disposed between the first and second mirrors having a variable refractive index to tune the transmission peaks of the etalon and the resonant frequency of the laser resonant cavity.

11. The tunable laser of claim 10 further comprising a fixed etalon disposed along the optical path between the mirror and the semiconductor optical amplifier, said fixed etalon having a plurality of fixed transmission peaks corresponding to resonances of the fixed etalon, and wherein the tunable etalon is tuned to select a resonant frequency corresponding to one of the transmission peaks of the fixed etalon.

12. The tunable laser of claim 10 wherein the semiconductor optical amplifier comprises a gain section and a phase control section.

13. The tunable laser of claim 10 wherein said tunable etalon further comprises a silicon back plane, and wherein the etalon is fabricated as a liquid crystal on silicon structure on the silicon back plane.
